(19) United States
(12) Patent Application Publication
(10) Pub. No.: US 2015/0243175 A1
(43) Pub. Date: Aug. 27, 2015

(54) AUTOMATED DISCIPLINARY AND MOTIVATIONAL SYSTEM

(71) Applicants: KAVITA RAMAN, CUPERTINO, CA (US); Mahesh Godavarti, CUPERTINO, CA (US)

(72) Inventors: KAVITA RAMAN, CUPERTINO, CA (US); Mahesh Godavarti, CUPERTINO, CA (US)

(21) Appl. No.: 14/629,640

(22) Filed: Feb. 24, 2015

Related U.S. Application Data
(60) Provisional application No. 61/944,131, filed on Feb. 25, 2014.

(51) Int. Cl. G09B 5/00

(52) U.S. Cl. CPC G09B 5/00

(57) ABSTRACT

An automated system for implementing motivational and disciplinary approaches may include a monitoring device that determines whether a user has completed a target task, and an access control application and/or a reward management application operatively connected to the monitoring device. The reward management application may also be operatively connected to the access control application. The access control application may grant access to a desired activity upon receiving a communication from the monitoring device that the target task has been completed, while the reward management application may deposit reward points into a reward bank upon receiving a communication from the monitoring device that the target task has been completed. Alternatively, the access control application may be capable of granting access to a desired activity upon receiving a communication from the reward management application, which may also debit reward points from the reward bank when a desired activity is accessed.

### RELATED APPLICATION DATA

The present application is related to and claims the benefit of commonly-owned co-pending U.S. Provisional Patent Application Ser. No. 61/944,131 entitled AUTOMATED DISCIPLINARY AND MOTIVATIONAL SYSTEM, filed on the Feb. 25, 2014, which application is incorporated herein by reference in its entirety.

### TECHNICAL FIELD

The present invention relates generally to disciplinary and motivational systems and, more particularly, to an automated disciplinary and motivational system controlling access to activities and rewards.

### BACKGROUND

The common approach toward motivating people to perform many necessary but unpleasant tasks is to either make the tasks fun using games and social interaction or to use a rewards based system. Common examples of such tasks include dieting, exercising, learning, and homework. Existing methods may be effective, provided the person actually engages with the task. However, forcing engagement can be difficult.

The most common engagement approach is the carrot and stick method. A typical example involves parents withholding access to television, video games, or imposing curfew until the homework is completed. Once the homework is complete, the child may not only be able to access or engage in the withheld privileges, but also possibly receive additional rewards. In this scenario, the withholding of the privileges would be the stick part of imposing discipline, which may cause resentment between the child and the parent, while the access to additional rewards would be the carrot part of imposing discipline.

The connectivity of today's society is constantly growing with the growing popularity of smartphones and tablets, social networks, multiple applications that require the internet, multiple applications that require electrical power, migration of many popular activities to the internet and smartphones, and wearable electronic gadgets. But, there are no automated means of imposing discipline wherein access to a desired activity, such as a smartphone application or the internet, is dependent upon target tasks being completed. Rather, the desired activities are conventionally manually turned off or deactivated instead of being automatically controlled.

### SUMMARY OF THE INVENTION

Some embodiments of the present invention include an automated system for implementing motivational and disciplinary approaches, the system including a monitoring device capable of determining whether a user has completed a target task, and an access control application and/or a reward management application operatively connected to the monitoring device. The reward management application may also be operatively connected to the access control application. The access control application may be capable of granting access to a desired activity upon receiving a communication from the monitoring device that the target task has been completed, while the reward management application may be capable of depositing reward points into a reward bank upon receiving a communication from the monitoring device that the target task has been completed. Alternatively, the access control application may be capable of granting access to a desired activity upon receiving a communication from the reward management application, which may also be capable of debiting reward points from the reward bank when a desired activity is accessed.

### BRIEF DESCRIPTION OF THE FIGURES

A detailed description of some embodiments of the invention is made below with reference to the accompanying figures, wherein like numerals represent corresponding parts of the figures.

FIG. 1 is a detailed relationship/functional diagram of one embodiment of the present invention showing a reward bank interaction with different modules.

FIG. 2 is a relationship diagram of one embodiment of the present invention showing the interaction between different modules without a reward bank.

FIG. 3 is a relationship diagram of one embodiment of the present invention showing the interaction between different modules with a reward bank.

FIG. 4 is a flow chart for one embodiment of the present invention in which a user's access to the internet is dependent on the user's completion of homework.

FIG. 5 is a flow chart for an embodiment of the present invention in which access to a smartphone messaging application is dependent on the user's completion of homework.

FIG. 6 is a flow chart for a monitoring application in accordance with one embodiment of the present invention.

FIG. 7 is a flow chart for access control in accordance with one embodiment of the present invention.

FIG. 8 is a flow chart for user/users/team accessing desired activities in accordance with one embodiment of the present invention.

FIG. 9 is a schematic representation of an embodiment of the present invention interconnected through the internet to users, administrators, target activities, and desired activities.

### DETAILED DESCRIPTION OF CERTAIN EMBODIMENTS

The system of the present disclosure may be used to implement disciplinary and motivational approaches and may comprise the following elements. The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention. In addition, it will be clear and apparent to one skilled in the art that the invention is not limited to the embodiments set forth and that the invention can be adapted for any of several applications.

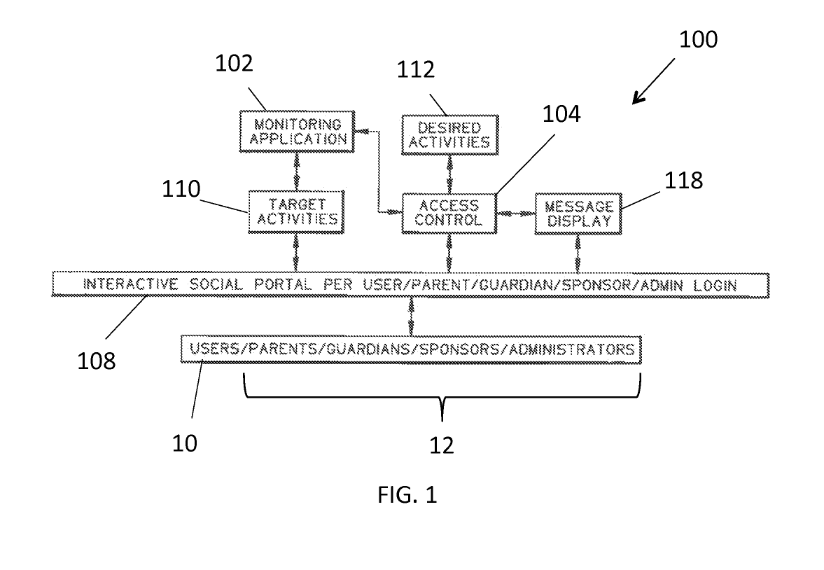

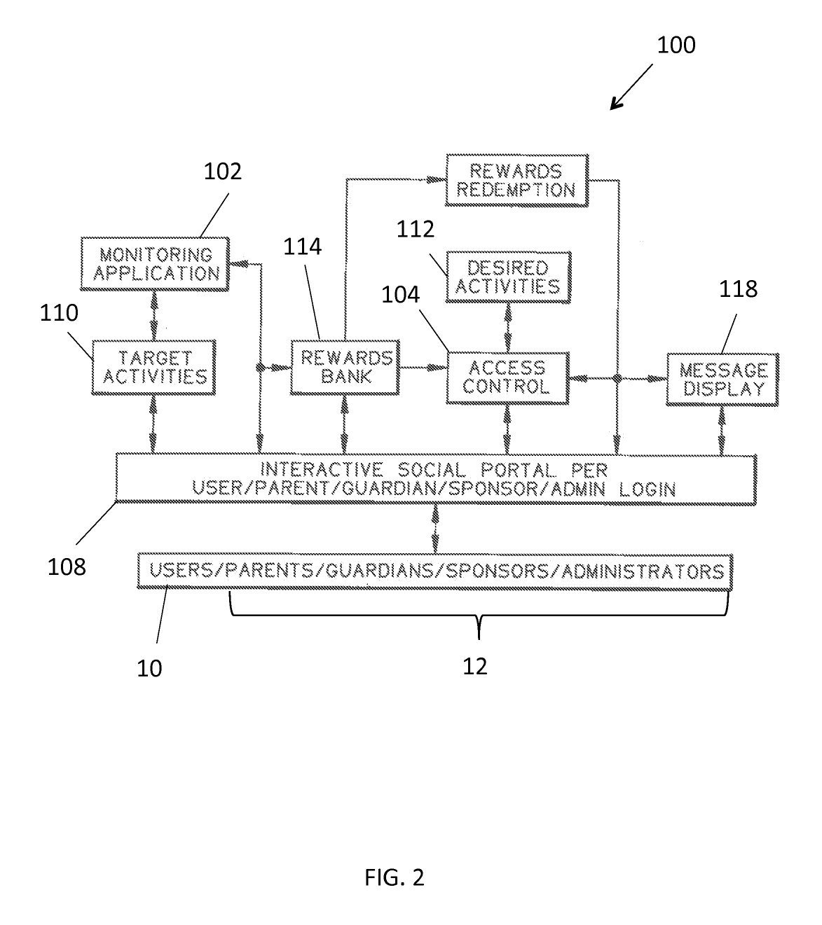

FIGS. 1-9 illustrate embodiments of an automated system 100 for implementing disciplinary and motivational approaches. Referring first to FIGS. 1, 2, and 9, the system 100 may comprise a monitoring device or application 102 operatively connected to an access control application 104 which is operatively connected to a communication media, such as an interactive social portal 108, through which a user 10 and an account manager 12, such as parents, guardians, sponsors, or other administrators, may access the system 100. The monitoring device 102 may monitor the activities of a user 10 or a team to determine whether a target task or activity 110 has been completed and communicates the determination to the access control application 104. When the target task 110 has been completed, access to a desired activity 112 may be granted or reward points may be deposited into a reward bank 114 (FIG. 2). Any appropriate internet protocol, or combination of protocols, may be used for communication among the monitoring device 102, the rewards bank 114, and the access control application 104. Such protocols may include, but are not limited to, HTTP, RADIUS, and TCP. In addition, various IoT (internet of things) protocols may be used for communication among the monitoring device 102, the rewards bank 114, and the access control application 104. Such protocols may include, but are not limited to, MQTT and XMPP.

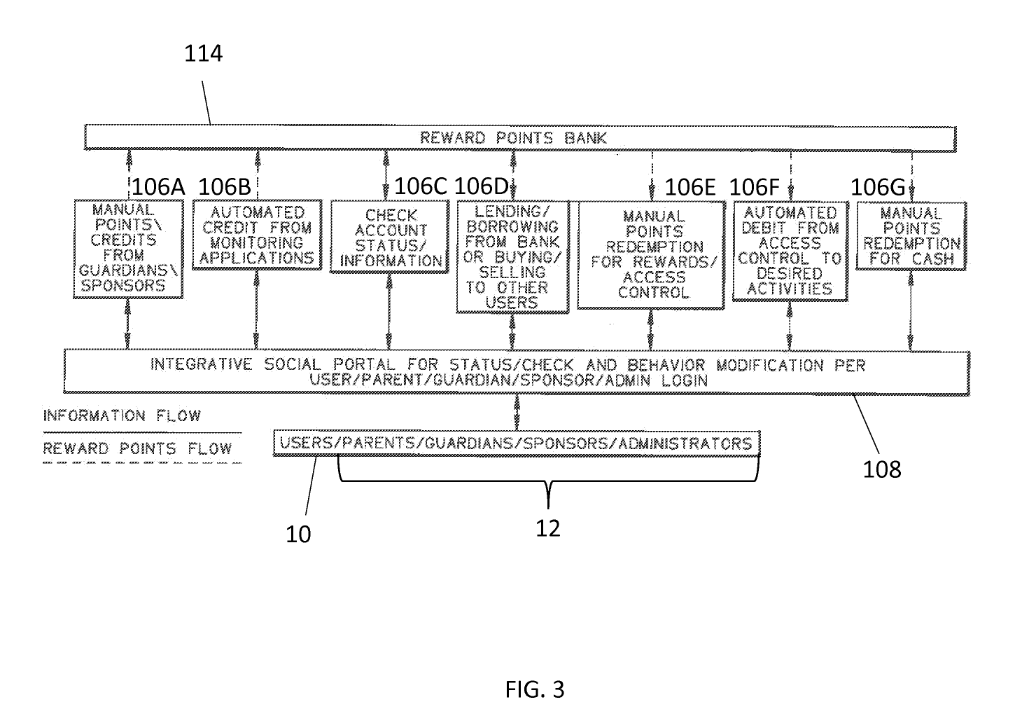

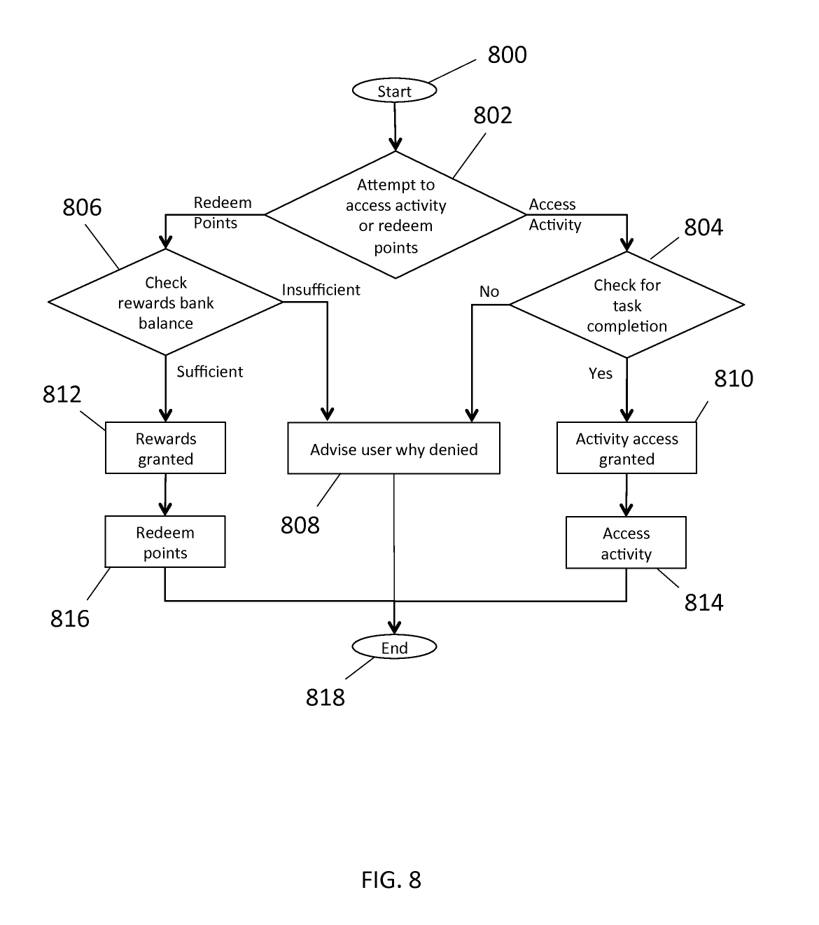

Referring to FIG. 8, for example, to begin (step 800), when a user 10 (step 800) may try to access a desired activity 112 or redeem 116 reward points (step 802), the access control application 104 or a reward management application 106 (FIG. 3) may communicate with the monitoring application 102 to determine whether the target task 110 has been completed (step 804) and/or whether there are sufficient reward points (step 806) for the desired activity 112 or reward. If the target task 110 has not been completed, a communication media 108 may communicate to the user 10 (step 808) why access is denied and the process ends (step 818). Alternatively, if the user 10 has completed the target activity, the user 10 may be granted access to the desired activity 112 (step 810), which may be communicated to the user 10 by the communication media 108. In other embodiments, when a user 10 tries to redeem reward points, the reward management application may communicate with the reward bank 114 (step 806) to determine whether there are sufficient reward points for the desired activity 112 or reward. If there are insufficient funds, the communication media 108 may communicate to a user 10 (step 808) the balance of the reward bank 114 and the additional funds required and the process ends (step 818). If there are sufficient funds, the reward management application 106 may deduct the reward points from the reward bank 114 and provide the reward points to the user 10 (step 812). The user 10 may then redeem the reward points (step 814) to access a desired activity 112, or the user 10 may redeem the reward points for physical rewards (step 816) and the process ends (step 818). Thus, the user 10 requesting action in existing products, such as access to certain features, may be dependent upon approval from the monitoring device 102 or reward management application 106.

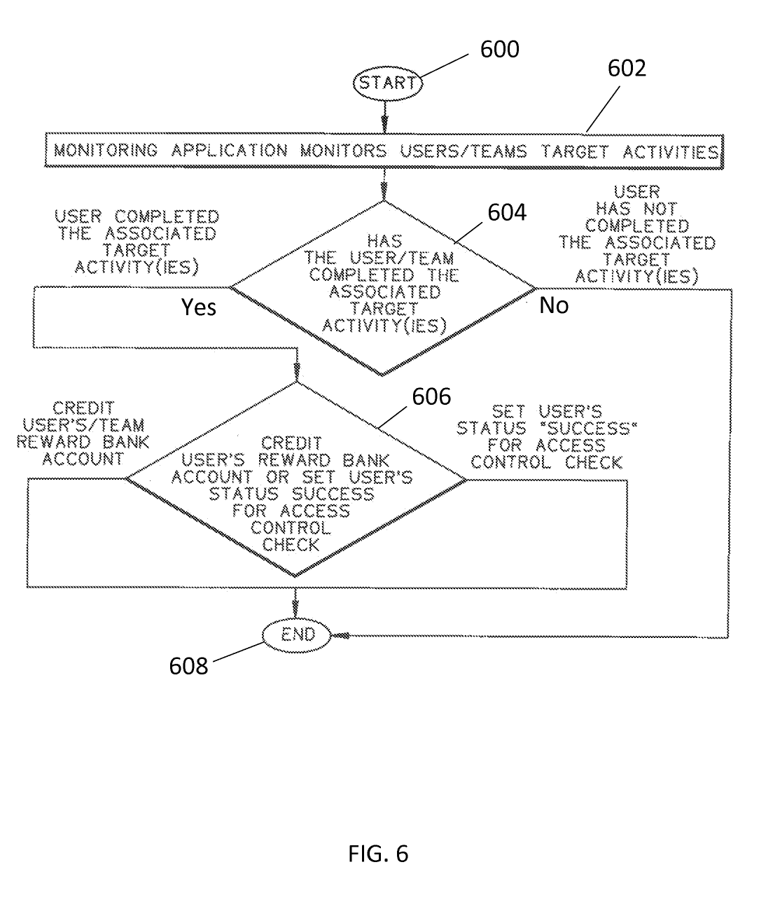

Embodiments of the system 100 may incorporate both monitoring application 102 and a reward management application 106, as shown in FIG. 6. After the process begins (step 600), the monitoring application 102 monitors the target activities 110 of the user 10 (or team) (step 602). A determination is made as to whether the user 10 has completed the target activity or activities 110 (step 604). If so, a user 10 may choose (step 606) whether completion of the target task 110 results in access to a desired activity 112 being granted (or the user's status for use by the access control application 104 being set to “success”) or in reward points being deposited into the reward bank 114 after which the process ends 608). If the use 10 has not completed the target activity 110, the user 10 receives no points or rewards and the process ends (step 608). In other embodiments, the completion of certain target tasks 110 may automatically (without a decision by the user 10) result in access to desired activities, while completion of other target tasks 110 may automatically result in reward points being deposited into a reward bank 114 by the reward management application 106.

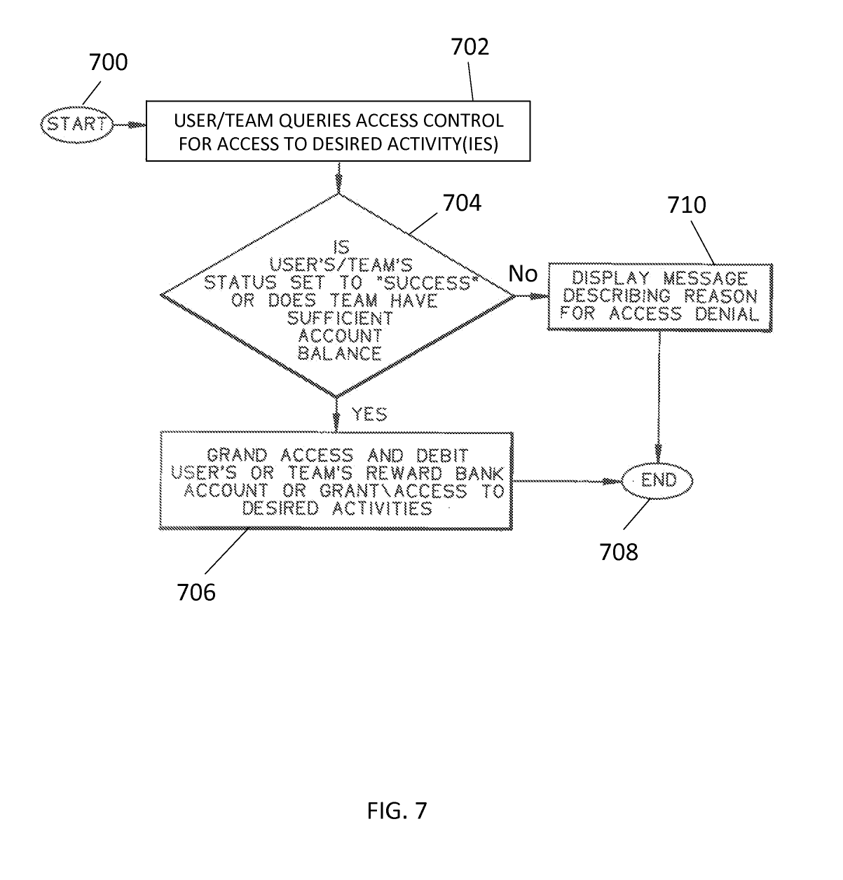

The system 100 may also incorporate an access control application 104, as shown in FIG. 7. After the process begins (step 700) and the user or team 10, has engaged in one or more target activities 110, the user or team 10 may either attempt to access the desired activity 112 or query the access control application 104 (step 702). The access control application 104 makes a determination (step 704) if a status indicator of the user or team 10 has been set to “success” or if the user or team 10 has enough points in the rewards bank 114 to access the desired activity 112. If so, access to the desired activity 112 is granted and points are debited from the user or team's rewards bank 114 account (step 706) and the process ends (step 708). Otherwise, the user or team 10 receives a message through the message display 118 indicating why access was denied (step 710) and the process ends (step 708). If included, the reward bank 114, through the reward management application 106, may be capable of receiving deposits of reward points, storing reward points, and providing debits of reward points. As indicated by the arrows in FIG. 3, the reward management application 106 may enable rewards points to be added to or subtracted from the reward bank 114. The reward bank 114 may also be capable of transferring, sharing, and borrowing reward points with a second reward bank 114. More specifically, as illustrated in FIG. 3, the reward management application 106 may include one or more of the following functions: allow points from the administer 12 to be manually added (credited) to the reward bank 114 of a user 10 (106A); allow points to be automatically added to the reward bank 114 by the monitoring application 102 (106B); allow a user 10 or administrator 12 to check the account status and other information, such as the number of stored reward points and the history of deposits and withdrawals of the reward points, in the reward bank 114 of a user 10 (106C); allow points to be lent or sold by the user 10 from the reward bank 114 to a third party or borrowed or bought by the user 10 from a third party (106D); allow points to be transferred from the account of one user to the account of another user; allow a user 10 to manually redeem reward points (106E); allow points to be automatically subtracted (debited) from the reward bank 114 by the access control application 104 to permit the user 10 to engage in a desired activity 112 (106F); and allow points to be redeemed from the reward bank 114 for cash (106G). Thus, in many respects, the reward bank 114 may function similarly to a conventional bank, wherein the currency is reward points rather than money.

The automated system may also comprise a network that grants an account manager or administrator 12, such as a parent, a guardian, a physical trainer, a teacher, or a doctor, the ability to configure the settings for the desired activities 112, the target tasks 110, and the reward bank 114. Thus, an account manager 12 may be able to set what target tasks 110 need to be completed for the user 10 to have access to a desired activity 112 or to earn a particular number of reward points. The account manager 12 may also determine how many reward points it takes to access a desired activity 112 or reward and have the authority to manually add reward points into the reward bank 114 (106A).

Examples of target activities 110 to be completed include online learning/education, diet/exercise, web-surveys, chores, advertisements, acknowledgement of reminders, and competition of any kind. However, the system 100 may be adapted to promote the completion of any desired target activity 110.

Upon completion of the target activity 110, a user 10 may have access to a desired activity 112 and/or reward. Examples of desired activities/rewards 112 include gift cards or access to funds on gift cards, access to funds on credit cards, TV privileges, such as the ability to turn on the TV or the ability to access cable programming, internet privileges, access to a social network, the ability to use a physical object or toy, video game privileges, access to smartphone applications, phone call/text message privileges, the ability to start a car or open a door, and the usage of a device, such as a laptop, smartphone, or phone. Other embodiments of the system 100 may control the usage of a device, such as a cellular phone, such as a smartphone, a tablet, a laptop, a TV, an internet TV, or any other electronic device, wherein the access control application 104, such as a web-power switch, or the reward management application 106 may restrict the power to the device or may restrict the ability for certain programs to run until the target task 110 has been completed or until sufficient reward points have been accumulated by the user 10. The target task 110 may be any task that the electronic device can either detect locally or can be intimated about via communication from the monitoring device 102. If the target task 110 is incomplete, access to the electronic device's functions may be restricted until the target task 110 is completed. Thus, access to games, the internet, calling or texting applications, or any other specified applications, i.e. the desired activity 112, may be restricted until the target task 110 is completed or until the reward bank 114 has a sufficient balance of reward points.

By way of a further example, an embodiment of the system 100 may be an enhancement on existing e-learning tablets that are distributed in schools, allowing desired activities to be accessed if sufficient progress is made on the e-learning tasks 110 rather than having the desired activities 112 permanently disabled. Other embodiments may control access to a social network by restricting the ability to post or chat with other users 10 until a target task 110, such as homework, is completed. In some embodiments, the system 100 may provide discounted travel expenses to a user 10 learning a language. In this instance, the language learning application may be tied to a travel program. Thus, the desired activity 112 in this example is discounted travel costs, while the target task 110 is learning a new language.

Suitable monitoring applications 102 for implementing disciplinary and motivational approaches determine whether the target task 110 has been completed and include a wearable monitoring device capable of reading vital signs, internet monitoring software, URL tracking software, self-monitoring by the target activity, GPS for tracking distance traveled, microphone for audio tracking, and a camera for visual tracking. However, the system may be adapted to use any desired monitoring device 102.

Suitable access control applications 104 include electronically controlled physical locks, such as locks on a car door or a room, electronic starters on automobiles, web-filters, a power control, escrow accounts, a captive portal, proxy, firewall, and smartphone access controls. Alternatively, the access control application 104 may be a conditional execution statement designed to replace existing execution statements in electronics and software, wherein the conditional execution statement requires the target task 110 being completed to begin execution of a desired activity 112. In the instance of a web-filter access control application, the web-filter may regulate internet traffic and may include software capable of going online or checking locally on a computer to determine whether the target task 110 has been completed. In the instance of a captive portal, the portal may not only verify the user's 10 identity, but may also use the identity of the user 10 to determine whether access to an application, such as the internet, should be granted. However, the system 100 may be adapted to use any desired access control application. Suitable reward management applications 106 may be capable of adding reward points to and subtracting reward points from a reward bank 114.

Some embodiments of the system 100 include multiple access control applications 106. For example, an embodiment may have both a web-filter and captive portal, wherein the behavior of the web-filter and captive portal may depend on an individual user's 10 credentials. In this embodiment, a history may be stored for each user 10 and access to a desired activity 112 may depend on the user's 10 credentials. Similarly, an embodiment may have any combination of a web-filter, captive portal, HTTP proxy, and firewall.

Suitable communication media 108 include internet/web representational state transfer (RESTful) application programming interface (API) or proprietary direct API calls, phone call/SMS text, Bluetooth®, direct API calls when the communicating modules reside locally with each other, audio signals, video signals, and OS system API calls. However, the system 100 may be adapted to use any desired communication media 108. The communication media 108 may communicate to the user 10 by a message display 118 (FIG. 1). The message display 118 may indicate what target activities 110 need to be completed, if access to a desired activity 112 is granted or denied, and information regarding reward points. If access is denied, the message display 118 may also communicate why the access to the desired activities 112 has been restricted. Suitable message displays 118 include a smartphone display, a laptop screen, an audio message played from any device capable of playing audio, an HTML display within an internet browser, a message within a social network, an LED display on physical devices, a TV screen, a video message, an SMS text, a phone call, and an email. However, the system 100 may be adapted to use any desired message display 118.

If being used in a group setting, such as a school classroom, the system 100 may be adapted to support team formation, collective team access, and collective target activities 110. The same system 100 may be shared among a number of individuals and, depending on the user's 10 login information, the system 100 may restrict or grant access. It will be appreciated that all of the actions of a single user 10, such as completing a target activity or task 110 and accessing a desired activity 112, are equally applicable to a team or group of individuals who together complete a target activity 110 and access a desired activity 112.

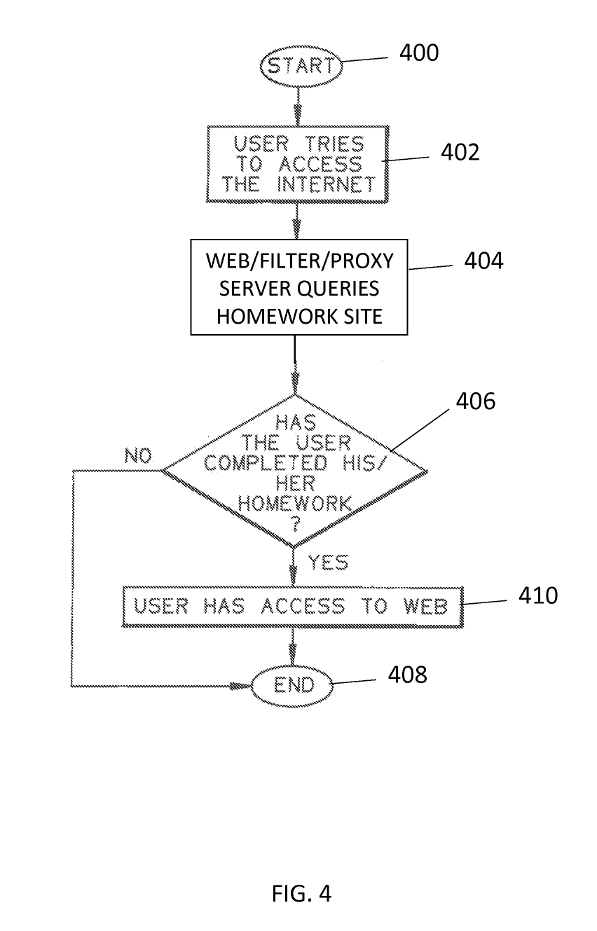

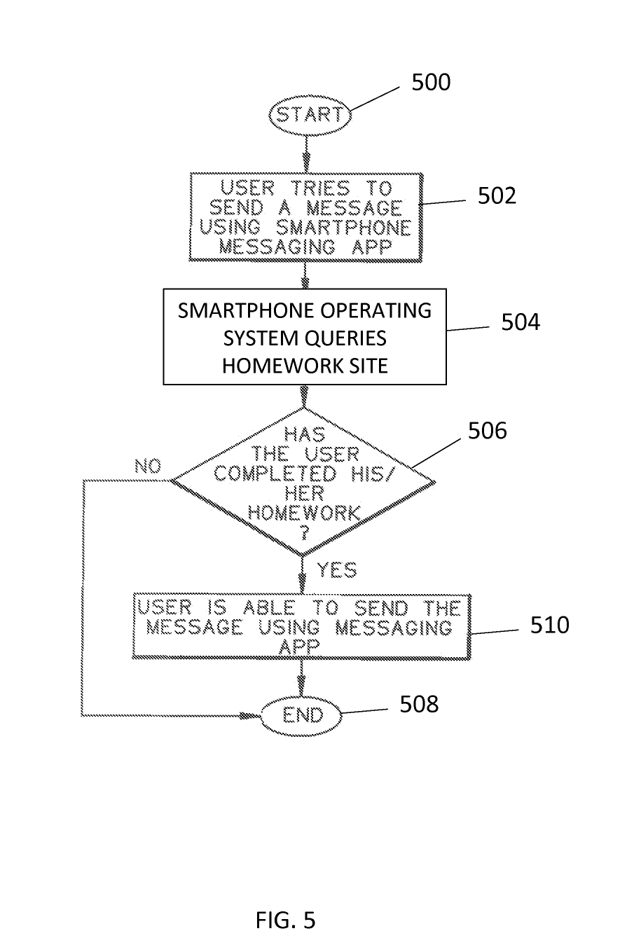

Referring to FIGS. 4 and 5, embodiments of the system 100 may be used to motivate a student to complete homework or online learning lessons. In the embodiment shown in FIG. 4, to start (step 400) when the user 10 tries to access the internet (step 402), a server (access control application 104) may communicate with a homework website (monitoring device 102) (step 404) to determine whether the user 10 has completed target activity 110 homework (step 406). The access control application 104 may be a web-filter, HTTP proxy and/or firewall residing on a computer that denies access to the internet until the learning tasks are completed or a captive portal residing on a router that denies access to the internet until the learning tasks are completed. The communication media 108 may be a browser generating web-pages to be displayed on the user's monitor. In other embodiments, the access control application 104 may be a web-powered switch that prevents devices from being switched on until the learning tasks are completed. In this case, the communication media 108 may be a message display 118 built into the web-powered switch that displays messages based on the information received from the access control application 104. The access control application 104 may also be software designed to regulate internet traffic and to provide controlled access (by amount of time or number of websites available) to the internet depending on what percentage of the target task 110 has been completed. For example, a web-filter, HTTP proxy or firewall (as an access control application 104), instead of only checking against a database of allowable websites and granting access to only those websites, may also contact the monitoring device 102 to determine whether the target task 110 has been completed and/or the rewards bank 114 to determine whether there is a sufficient balance to access the desired website. Referring again to FIG. 4, if the user 10 has not completed the required homework or the online lessons, the access control application 104 denies the user 10 access, or limits the user's 10 access, to the internet and the process ends (step 408). If the user 10 has completed homework or online learning lessons, the access control application 104 grants the user 10 access to the internet (step 410) and the process ends (step 408).

The system 100 shown in FIG. 5 is similar but the desired activity 112 is the ability of the user 10 to send a message from a smart phone if the homework (target activity 110) is completed. To start (step 500) when the user 10 tries to send a text message from a phone or other messaging device (step 502), the device's operating system (access control application 104) may query a homework website (monitoring device 102) (step 504) to determine whether the user 10 has completed homework (step 506). If the user 10 has not completed homework, the access control application 104 denies the user 10 the ability to send the text message and the process ends (step 508). If the user 10 has completed homework, the access control application 104 allows the user 10 to send the message (step 510) and the process ends (step 508).

Some embodiments may control the ability to use a physical object, such as a toy. In this case, a parent or guardian may purchase toys that are designed to function only when the target activity 110 is completed by a child. The toys may be capable of communicating with the monitoring device 102, such as a learning website, to determine whether the target task 110 is completed. Communication may be done using any suitable means, such as by a physical cable or by a wireless connection. The toys may also be capable of communicating to the child that they will only function when the target task 110 has been completed.

The system 100 may also be used to make payments of money based on target goals achieved. For example, the monitoring device 102 may check for a completed target task 110, such as homework, good grades, or progress towards fitness goals and make a payment into an account if the target goals are achieved. The account may be a phone account, resulting in phone services being available if target tasks 110 are completed and payment is made or terminated if target tasks 110 are not completed and the payment is not made. Alternatively, the account could be a bank account, such that funds are deposited into the bank account when target tasks 110 are completed.

Thus, one embodiment of the system 100 may function like a conditional bank account. In this embodiment, the account communicates with the monitoring device 102 to determine if a target task 110 has been completed. If the target task 110 has been completed, the access control application 104 may permit the account to allow an ATM card to access the account to withdraw funds. If the target task 110 has not been completed, the access control application 104 may direct the account to temporarily restrict access to the account by the ATM card until the target task 110 is completed. Alternatively, the account may also be connected to the reward bank 114 through the access control application 104 and the account may communicate with the reward bank 114 to determine if sufficient reward points have been deposited. If the reward bank 114 does not have a sufficient balance, even if the bank account does have a sufficient balance, access to the account by an ATM card may be denied. In one variation, a child's bank or credit card account may be linked to the child's reward bank 114 with the amount of money that the child can withdraw from the bank account or charge to the credit card is linked to the balance in the reward bank 114.

Some embodiments of the system 100 may tie into video games and may require target tasks 110 being completed or there being a sufficient balance in the reward bank 114 to have access to a subsequent level.

In some embodiments, the system 100 may deliver e-greetings upon completion of certain tasks 110 or availability of rewards balance to demonstrate sincerity in the delivered greetings on the part of the sender.

Another embodiment of the system 100 may involve an online fund raising site where people may raise money for their causes by completing tasks 110 that may be verified automatically using monitoring devices 102 and the completion of the tasks 110 may trigger funds being donated (desired activity 112) to the charity of choice. For example, an individual or each member of a team may wear a monitoring device 102 that logs the distance run by the wearer. When the monitoring device 102 has logged a pledged distance, or the combined distance run by the team members reaches a pledged distance, then funds may be released to a charitable organization, or funds may be released on a per-mile basis.

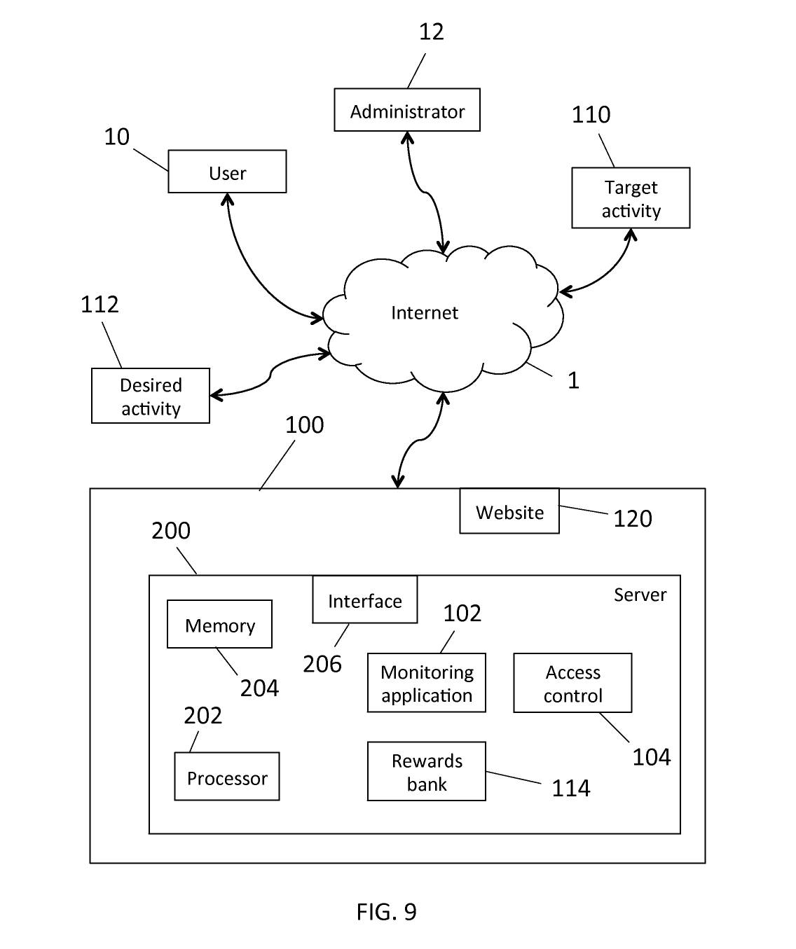

Referring again to FIG. 9, in an embodiment of the present invention, the system 100 may comprise a server 200 on which the monitoring application 102, access control application 104, and rewards bank 114 are hosted. The server 200 may include a processor 204 and a memory 202 configured to store instructions executable by the processor 204. The monitoring application 102 and access control 104 may comprise modules of instructions stored in the memory 202 and the rewards bank 114 may comprise a database stored in the memory 202. It will be appreciated that the memory 202 may be any type, or combination of types, of memory or data storage device. The server 200 may also include an interface 206 through which the server 200, by way of the website 120, is coupled to the internet 1, thereby allowing users 10 and administrators 12 to communicate with the server 200. The system 100 may be accessed by the user 10 and administrator 12 through an internet 1 website 120. Progress towards completing the target activity 110 may be monitored, and access to the desired activity 112 may restricted and allowed, through the internet 1. It will be appreciated that users 10 and administrators 12 may access the system 100 using any internet-connected electronic device, including, smartphones, tablets, computers, internet-connected video games, automobiles, wearable devices, internet-connected televisions and telephones, among others. Users 10 and administrators 12 may access the system 100 through web browsers specific client software (apps) running on their electronic devices. Interconnection between users 10 and administrators 12 with the target activity 110, desired activity 112, and the system 102 may also be facilitated using any other wired or wireless communication protocol.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An automated system for implementing motivational and disciplinary approaches, the system comprising:
a monitoring device capable of determining whether a user has completed a target task; and
an access control application operatively connected to the monitoring device, the access control application being capable of granting access to a desired activity or completing a desired action upon receiving a communication from the monitoring device that the target task has been completed.

2. The automated system of claim 1, further comprising a communication media configured to communicate to a user whether access to the desired activity has been granted.

3. The automated system of claim 1, further comprising a network that is configured to allow an account manager to control system settings for the target task and the desired activity.

4. The automated system of claim 1, wherein the target task is a member selected from the group consisting of homework, diet/exercise, chores, web-surveys, advertisements, and competition.

5. The automated system of claim 1, wherein the desired activity or the desired action is a member selected from the group consisting of TV privileges, internet privileges, access to a social network, ability to share accomplishments on a social network, access to a bank account, video game privileges, access to smartphone applications, ability to make a phone call, ability to send a text message, and usage of an electronic device.

6. The automated system of claim 1, wherein the access control application is a member selected from the group consisting of an electronically controlled physical lock, a web-filter, a captive portal, power control, escrow accounts, a smartphone access control application, and a conditional execution statement.

7. The automated system of claim 1, wherein the monitoring device is a member selected from the group consisting of a wearable monitoring device capable of reading vital signs, internet monitoring software, URL tracking software, self-monitoring by the target activity, GPS for tracking distance traveled, microphone for audio tracking, and a camera for visual tracking.

8. The automated system of claim 1, wherein the communication media is a member selected from the group consisting of a representational state transfer application programming interface call, a direct application programming interface call, a phone call, a text message, a Bluetooth device, an audio signal, a video signal, and an operating system application programming interface call.

9. An automated system for implementing motivational and disciplinary approaches, the automated system comprising:
a monitoring device capable of determining whether a target task has been completed; and
a reward bank operatively connected to the monitoring device, the reward bank being capable of receiving reward points deposits into a user account upon receiving a communication from the monitoring device that the target task has been completed, and the reward bank being capable of debiting reward points from the user account when a desired activity is accessed or a desired action is completed.

10. The automated system of claim 9, wherein:
the reward bank is capable of transferring, sharing, and borrowing reward points with a second reward bank; and
a third party application can access the reward bank to check a balance of the reward points in the user account and a history of deposits and withdrawals of the reward points in the user account.

11. The automated system of claim 9, further comprising a communication media configured to communicate to the user whether reward points have been deposited into the reward bank.

12. The automated system of claim 9, further comprising a network that is configured to allow an account manager to control system settings for the target task and the reward bank.

13. The automated system of claim 9, wherein the reward points may be redeemed to access a desired activity, to complete a desired action, or for a physical reward.

14. An automated system for implementing motivational and disciplinary approaches, the automated system comprising:
a monitoring device capable of determining whether a target task has been completed;
a reward bank operatively connected to the monitoring device, the reward bank being capable of receiving reward points deposits into a user account upon receiving a communication from the monitoring device that the target task has been completed; and
an access control application operatively connected to the monitoring device and the reward bank, the access control application being capable of granting the user access to a desired activity or completing a desired action upon receiving a communication from the monitoring device that the target task has been completed, and the access control application being capable of granting access to a desired activity or completing a desired action upon receiving a communication from the reward bank that the user account in the reward bank has a sufficient balance of reward points to access the desired activity or to complete the desired action, the reward bank being capable of debiting reward points from the user account when the desired activity is accessed or the desired action is completed;
wherein the system is configured to allow the user to select between access to the desired activity or having reward points deposited to the reward bank upon completion of the target task.

16. The automated system of claim 14, further comprising a network that is configured to allow an account manager to control system settings for the target task and the reward bank.

17. The automated system of claim 14, further comprising a server comprising:
a processor;
a memory configured to store instructions, wherein the monitoring device, the reward management application, and the access control application each comprise a module of instructions stored in the memory and executable by the processor; and
an interface coupled to the internet and configured to permit communication among users, administrators, target activities, desired activities, the monitoring device, the reward management application, and the access control application.

18. The automated system of claim 14, wherein the monitoring device is further capable of:
determining if the user attempts to access the internet;
querying the target task to determine if the user has completed the target task;
directing the access control application to allow the user to access the internet if the user has completed the target task; and
directing the access control application to deny the user access to the internet if the user has not completed the target task.

19. The automated system of claim 14, wherein the monitoring device is further capable of:
determining if the user attempts to send a text message;
querying the target task to determine if the user has completed the target task;
directing the access control application to allow the user to send the text message if the user has completed the target task; and
directing the access control application prevent the user from sending the text message if the user has not completed the target task.

20. The automated system of claim 14, wherein the monitoring device is further capable of:
determining if the user attempts to use an ATM card to access a bank account;
querying the target task to determine if the user has completed the target task;
directing the access control application to allow the user to use the ATM card if the user has completed the target task; and
directing the access control application prevent the user from using the ATM card if the user has not completed the target task.
